(19) United States
(12) Patent Application Publication
(10) Pub. No.: US 2024/0180251 A1
(43) Pub. Date: Jun. 6, 2024

(54) AEROSOL GENERATING DEVICE

(71) Applicant: KT&G CORPORATION, Daejeon (KR)

(72) Inventors: Dong Sung KIM, Seoul (KR); Yong Hwan KIM, Gyeonggi-do (KR); Hun II LIM, Seoul (KR); Seok Su JANG, Daejeon (KR)

(73) Assignee: KT&G CORPORATION, Daejeon (KR)

(21) Appl. No.: 18/285,468

(22) PCT Filed: Jul. 21, 2022
(86) PCT No.: PCT/KR2022/010675

§ 371 Date: Oct. 3, 2023

(30) Foreign Application Priority Data
Jul. 21, 2021 (KR) 10-2021-0095614

(51) Int. Cl. A24F 40/465; A24F 40/20; A24F 40/51; A24F 40/57

(52) U.S. Cl. CPC A24F 40/465; A24F 40/51; A24F 40/20; A24F 40/57

(57) ABSTRACT

An aerosol generating device includes: a heater including an accommodating space for accommodating an aerosol generating article; and a coil configured to heat the heater by generating a magnetic field, wherein the heater includes a first region arranged to contact the aerosol generating article, and a second region arranged at at least one of two ends of the first region and extending in a direction away from a center of the accommodating space.

### TECHNICAL FIELD

The embodiments relate to an aerosol generating device, and more particularly, to an aerosol generating device into which an aerosol generating article may be smoothly inserted.

### BACKGROUND ART

Recently, the demand for alternative methods to overcome the disadvantages of traditional cigarettes has increased. For example, there is growing demand for an aerosol generating device which generates aerosol by heating an aerosol generating material, rather than by combusting cigarettes. Accordingly, researches on a heating-type aerosol generating device has been actively conducted.

Methods by which aerosol generating devices heat an aerosol generating article may be classified into electrical resistance heating methods and induction heating methods. An induction aerosol generating device includes a heater arranged in or around the aerosol generating article and configured to generate heat in response to an external magnetic field.

### DISCLOSURE

### Technical Problem

In an induction aerosol generating device configured to heat a periphery region of an aerosol generating article, a heater includes an accommodating space accommodating the aerosol generating article therein. In this case, in a process of inserting the aerosol generating article into the accommodating space of the heater, due to friction with an inner wall of the heater, the aerosol generating article may not be smoothly inserted into the heater or may be damaged.

Accordingly, a technical problem to be solved by the embodiments is to provide an aerosol generating device into which an aerosol generating article may be smoothly inserted.

The technical problem to be solved by the embodiments is not limited to the aforementioned problem, and other unmentioned problems may be clearly understood by those skilled in the art according to the present specification and the accompanying drawings.

### Technical Solution

An aerosol generating device according to an embodiment includes a heater including an accommodating space into which an aerosol generating article is inserted and a coil configured to heat the heater by generating a magnetic field, and the heater includes a first region contacting the aerosol generating article, and a second region extending from at least one of two ends of the first region in a direction away from a center of the accommodating space.

Technical solutions are not limited thereto, and may include all the matters that may be derived by those of ordinary skill in the art throughout the present specification.

### Advantageous Effects

In an aerosol generating device according to embodiments, even an aerosol generating article inserted with an inclination with respect to a predetermined insertion direction may be smoothly inserted into the aerosol generating device.

Advantageous effects of the embodiments are not limited to the aforementioned description, and may include any effects that may be derived from the configurations to be described hereinafter.

### DESCRIPTION OF DRAWINGS

FIG. 1 is a schematic cross-sectional view of an aerosol generating device according to an embodiment;

FIG. 2 is a perspective view of a heater and an insulator of the aerosol generating device according to the embodiment shown in FIG. 1;

FIG. 3 is an exploded view of the heater and the insulator of the aerosol generating device according to the embodiment shown in FIG. 2;

FIG. 4A is a cross-sectional view of the heater and the insulator of the aerosol generating device according to the embodiment shown in FIG. 2;

FIG. 4B is an enlarged view of a portion of cross-sections of the heater and the insulator of the aerosol generating device according to the embodiment shown in FIG. 3;

FIG. 5 is a perspective view of a heater of an aerosol generating device according to another embodiment;

FIG. 6 is an exploded view of the heater of the aerosol generating device according to the embodiment shown in FIG. 5;

FIG. 7 is a cross-sectional view of the heater of the aerosol generating device according to the embodiment shown in FIG. 5;

FIG. 8 is a perspective view of a heater of an aerosol generating device according to another embodiment;

FIG. 9 is a cross-sectional view of the heater of the aerosol generating device according to the embodiment shown in FIG. 8;

FIG. 10 is a schematic diagram of an example of an aerosol generating article;

FIG. 11 is a schematic diagram of another example of an aerosol generating article;

FIG. 12 is a schematic diagram of another example of an aerosol generating article; and

FIG. 13 is a block diagram of an aerosol generating device according to another embodiment.

### BEST MODE

An aerosol generating device according to an embodiment includes: a heater including an accommodating space for accommodating an aerosol generating article; and a coil configured to heat the heater by generating a magnetic field, wherein the heater includes a first region arranged to contact the aerosol generating article, and a second region arranged at at least one of two ends of the first region and extending in a direction away from a center of the accommodating space.

The first region may include a protrusion portion protruding in a direction away from the center of the accommodating space.

The first region may include the protrusion portion protruding in a direction away from the center of the accommodating space, and the aerosol generating device may further include a temperature sensor arranged on the protrusion portion and configured to detect a temperature of the heater.

The aerosol generating device may further include an insulator coupled to at least a portion of the second region and configured to prevent heat of the heater from being transferred to outside.

The aerosol generating device may further include the insulator coupled to the second region, contacting a part of an end portion of the second region without contacting a remaining part of the end portion of the second region, and configured to prevent heat of the second region from being transferred to outside.

A surface of the second region may include a material preventing dissipation of heat from the heater.

The second region may be separably coupled to the first region, and may include a material different from a material of the first region.

A surface defined by an edge of an end portion of the second region may be inclined with respect to a direction perpendicular to a direction in which the accommodating space extends.

A heater for the aerosol generating device, according to an embodiment, may include the accommodating space for accommodating the aerosol generating article, a first region contacting the aerosol generating article, and a second region arranged at at least one of two ends of the first region and extending in a direction away from a center of the accommodating space.

The first region may include a protrusion portion protruding in a direction away from the center of the accommodating space.

A surface of the second region may include a material preventing dissipation of heat of the heater.

The second region may be separably coupled to the first region, and may include a material different from a material of the first region.

A surface defined by an edge of an end portion of the second region may be inclined with respect to a direction perpendicular to a direction in which the accommodating space extends.

### MODE FOR INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In addition, terms including ordinal numbers, such as “first” “second” used in the present specification, may be used to describe various components, but the components are not limited to the terms. The terms are only used to distinguish one component from other components.

Throughout the specification, “aerosol generating device” may indicate a device configured to generate an aerosol by using an aerosol generating article such that an aerosol that may be directly puffed into a lung of a user through the user's mouth.

Throughout the specification, “an aerosol generating article” is an article used for smoking. For example, the aerosol generating article may include a general combustion cigarette that is used in a method of ignition and combustion, or may include a heating type cigarette that is used in a method of being heated by the aerosol generating device. As another example, the aerosol generating article may include an article that is used in a method of heating a liquid included in a cartridge.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments will be described in detail with reference to the drawings.

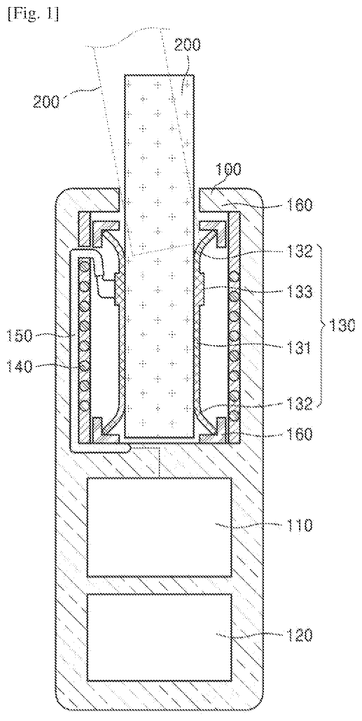

FIG. 1 is a schematic cross-sectional view of an aerosol generating device 100 according to an embodiment.

Referring to FIG. 1, the aerosol generating device 100 may include a controller 110, a battery 120, a heater 130, a coil 140, a temperature sensor 150, and an insulator 160. Components, arrangements, shapes, and the like of the aerosol generating device 100 shown in FIG. 1 are merely examples, and various embodiments applicable to the aerosol generating device 100 are not limited to the disclosure in the present specification.

The controller 110 may control general operations of the aerosol generating device 100. In an embodiment, the controller 110 may include at least one processor. The processor may be implemented as an array of a plurality of logic gates, and may also be implemented as a combination of a general-purpose microprocessor and a memory configured to store a program executable by the microprocessor. Those skilled in the art may understand that the processor may be implemented as other types of hardware.

The controller 110 may control a temperature of the heater 130 by controlling supply of power of the battery 120 to the coil 140. For example, the controller 110 may control power supply by controlling switching of a switching element between the battery 120 and the coil 140.

The controller 110 may analyze a result detected by the temperature sensor 150 and control processing operations to be performed later. For example, the controller 110 may control power supplied to the coil 140 to initiate or end operations of the coil 140, on the basis of the result detected by the temperature sensor 150. As another example, on the basis of the result detected by the temperature sensor 150, the controller 110 may control an amount of power supplied to the coil 140 and a time for supplying power, such that the heater 130 may be heated to a certain temperature or may maintain an appropriate temperature.

The battery 120 may supply power for operation of the aerosol generating device 100. The battery 120 may supply power to the coil 140 such that the heater 130 may be heated. In addition, the battery 120 may supply power for operation of other components (for example, the temperature sensor 150) provided in the aerosol generating device 100. The battery 120 may include a rechargeable battery or a disposable battery. For example, the battery 120 may include a lithium polymer (LiPoly) battery, but is not limited thereto.

The heater 130 may heat the aerosol generating article 200 by generating heat due to an alternating magnetic field applied from the outside. The aerosol generating device 100 may generate an aerosol by heating the aerosol generating article 200, which is accommodated in the aerosol generating device 100, by the induction method.

More particularly, the induction method may indicate a method of applying an alternating magnetic field, which periodically changes directions thereof, to a magnetic substance that generates heat due to an external magnetic field.

When the alternating magnetic field is applied to the magnetic substance, an energy loss due to an eddy current loss and hysteresis loss may occur to the magnetic substance, and the lost energy may be emitted as heat energy from the magnetic substance. As the alternating magnetic field applied to the magnetic substance has a greater amplitude or frequency, a greater amount of heat energy may be emitted from the magnetic substance. Heat energy may be discharged from the magnetic substance by the alternating magnetic field applied to the magnetic substance, and the heat energy discharged from the magnetic substance may be delivered to the aerosol generating article.

At least a portion of the heater 130 may include a ferromagnetic substance. For example, the heater 130 may include metal or carbon. The heater 130 may include at least one of ferrite, ferromagnetic alloy, stainless steel, and aluminum (Al). In addition, the heater 130 may include at least one of graphite, molybdenum, silicon carbide, niobium, nickel alloy, a metal film, ceramic such as zirconia, a transition metal such as nickel (Ni) or cobalt (Co), or a metalloid such as boron (B) or phosphorus (P).

The heater 130 may include a first region 131 and a second region 132. The first region 131 may include an accommodating space 131a in which at least a portion of the aerosol generating article 200 is accommodated. A shape of the first region 131 is not limited as long as the first region 131 may include the accommodating space 131a capable of accommodating the aerosol generating article 200. For example, the first region 131 may have a tubular shape, and the accommodating space 131a included therein may also have a tubular shape.

As another example, two end portions of the first region 131 have a tubular shape, and a center portion of the first region 131 may have a shape in which a plurality of sheets are apart from each other and extend in parallel to a longitudinal direction of the first region 131 to connect the two end portions of the first region 131. Here, the longitudinal direction of the first region 131 may indicate a direction in which the first region 131 extends, and may indicate a direction with a relatively greater length.

When the aerosol generating article 200 is accommodated in the accommodating space 131a, the first region 131 may contact the aerosol generating article 200. For example, when the aerosol generating article 200, which is cylindrical, is accommodated in the accommodating space 131a, the first region 131 may have a shape surrounding an outer circumstance of the aerosol generating article 200, but is not limited thereto. As another example, the first region 131 may be arranged such that when the aerosol generating article 200 is accommodated in the accommodating space 131a, a portion of the first region 131 surrounds at least a portion of the aerosol generating article 200 and a remaining portion of the first region 131 may be arranged apart from the aerosol generating article 200.

The first region 131 may include a protrusion portion 133 protruding in a direction away from a center of the accommodating space 131a. For example, the first region 131 may have a tubular shape, and the protrusion portion 133 may be a portion of the first region 131, which extends in the longitudinal direction of the first region 131, and may have a thickness greater than a thickness of the remaining portion of the first region 131.

The protrusion portion 133 may be integrally formed with the first region 131. For example, the first region 131 may be fabricated by using a single sheet including a magnetic substance, and a thicker portion of the single sheet may be the protrusion portion 133. The protrusion portion 133 may be formed by removing a portion of the first region 131 of the single sheet by an etching process or a mechanical method. The embodiments are not limited to the method of forming the protrusion portion 133. For example, the protrusion portion 133 may be fabricated independent of the first region 131 and coupled to an outer side of the first region 131. The protrusion portion 133 may be coupled to the first region 131 by welding, adhesive, or a combination tool such as a bolt or rivet.

As the protrusion portion 133 has a thickness different from a thickness of the remaining portion of the first region 131, when a variable magnetic field penetrates into the heater 130, magnetic force lines may not be uniformly concentrated. Accordingly, a portion of the first region 131, in which the protrusion portion 133 is arranged, may be heated to a temperature different from a temperature of a portion of the first region 131 in which the protrusion portion 133 is not arranged. Therefore, the heater 130 may heat portions of the aerosol generating article 200 accommodated in the accommodating space 131a to different temperatures as necessary.

The second region 132 may be arranged at an end portion of the first region 131 and may extend in a direction away from the center of the accommodating space 131a. Although FIG. 1 illustrates that the second region 132 is arranged at both ends of the first region 131, the second region 132 may be arranged at only one end portion of the first region 131 at which the aerosol generating article 200 enters the accommodating space 131a.

As shown with broken lines in FIG. 1, the aerosol generating article 200 may be inserted into the accommodating space 131a with inclination with respect to the direction in which the accommodating space 131a extends. Here, the second region 132 may extend in the direction away from the center of the accommodating space 131a, to thereby guide the aerosol generating article 200, which is inserted with inclination, to be smoothly inserted into the center of the accommodating space 131a.

The second region 132 may be curved in the direction away from the center of the accommodating space 131a to guide the aerosol generating article 200 to be smoothly inserted, but is not limited thereto. For example, the second region 132 may have a shape of a chamfer extending in the direction away from the accommodating space 131a.

The first region 131 and the second region 132 may be integrally formed. For example, the first region 131 and the second region 132 may be fabricated by using a single sheet including a magnetic substance, but are not limited thereto. The first region 131 and the second region 132 may be separately fabricated, and may be separably coupled to each other.

The coil 140 may apply the alternating magnetic field to the heater 130. When power is supplied to the coil 140, a magnetic field may be formed in the coil 140. When an alternating current is applied to the coil 140, a direction of the magnetic field formed in the coil 140 may be continuously changed. When the heater 130 is in the coil 140 and exposed to the alternating magnetic field that periodically changes directions, the heater 130 may generate heat, and the aerosol generating article 200 accommodated in the heater 130 may be heated.

The coil 140 may be arranged at a suitable position to apply the alternating magnetic field to the coil 140. For example, the heater 130 may be arranged to face the aerosol generating article 200, and the coil 140 may be arranged at the outside of the heater 130. In this way, the efficiency of applying the alternating magnetic field of the coil 140 to the heater 130 may be improved due to a size and arrangement of the coil 140.

When an amplitude or a frequency of the alternating magnetic field generated by the coil 140 changes, the degree by which the heater 130 heats the aerosol generating article 200 may also be changed. The amplitude or frequency of the magnetic field generated by the coil 140 may be changed due to the power applied to the coil 140. Therefore, the aerosol generating device 100 may control heating of the aerosol generating article 200 by adjusting the power applied to the coil 140. For example, the aerosol generating device 100 may control the amplitude and frequency of an alternating current applied to the coil 140.

As an example, the coil 140 may be implemented by a solenoid. The coil 140 may include a solenoid wound along an outer surface of the accommodating space 131a of the heater 130, and the heater 130 and the aerosol generating article 200 may be arranged in an inner space of the solenoid. A wiring of the solenoid may include copper (Cu). However, the embodiment is not limited thereto, and an alloy including any one or at least one of silver (Ag), gold (Au), aluminum (Al), tungsten (W), zinc (Zn), nickel (Ni) may be the material of the wiring of the solenoid.

As shown in FIG. 1, the temperature sensor 150 may contact the heater 130. The temperature sensor 150 may detect a temperature to which the heater 130 is heated. The temperature sensor 150 may be connected to the controller 110 and may deliver a result of detection to the controller 110. The temperature sensor 150 may include, for example, a thermocouple, but is not limited thereto. The temperature sensor 150 may include any device capable of detecting the temperature of the heater 130.

As described above, on the basis of the result detected by the temperature sensor 150, the controller 110 may control an amount of power supplied to the coil 140 and a time for supplying power, such that the heater 130 may be heated to a certain temperature or may maintain an appropriate temperature.

For example, the temperature sensor 150 may be arranged at the protrusion portion 133 of the heater 130. To prevent the temperature sensor 150 from being separated from the surface of the heater 130, a portion of the temperature sensor 150 may be bound to the heater 130 by a coupling process such as welding. In this case, the risk of damaging the heater 130 in the coupling process may be reduced because the protrusion portion 133 has good durability of the protruding portion 133 due to its a relatively great thickness.

The insulator 160 may be coupled to at least a portion of the second region 132. The insulator 160 may prevent the heat of the heater 130 from being transferred to outside.

Referring to FIG. 1, the second region 132 may be arranged adjacent to the outer surface of the aerosol generating device 100, to thereby guide insertion of the aerosol generating article 200. The insulator 160 may be coupled to at least a portion of the second region 132, to thereby effectively decrease an amount of heat delivered from the second region 132 to the outside of the aerosol generating device 100. Accordingly, a stable usage environment of the aerosol generating device 100 may be provided to the user.

In addition, the insulator 160 may prevent heat of the second region 132 from being transferred to outside, to thereby decrease an amount of power wasted in the coil due to heat loss.

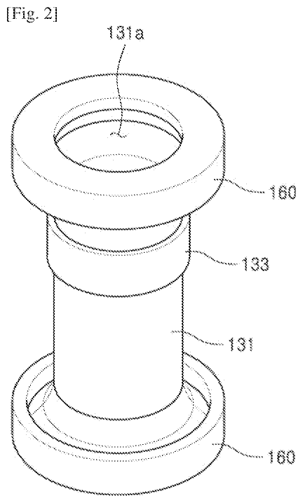

Hereinafter, the insulator 160 will be described in further detail with reference to FIGS. 2 to 4B.

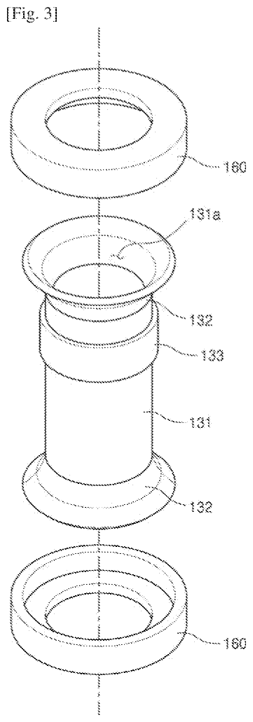

FIG. 2 is a perspective view of the heater 130 and the insulator 160 of the aerosol generating device 100 according to the embodiment shown in FIG. 1. FIG. 3 is an exploded view of the heater 130 and the insulator 160 of the aerosol generating device 100 according to the embodiment shown in FIG. 2.

Referring to FIGS. 2 and 3, the insulator 160 may be arranged along the entire circumference the second region 132, but is not limited thereto. For example, the insulator 160 may be arranged only at a portion of the circumference of the second region 132.

The insulator 160 may include a hole into which the aerosol generating article 200 may be inserted. For smooth insertion of the aerosol generating article 200, a size of the hole may be substantially identical to a size of a cross-section of the accommodating space 131a taken perpendicular to the longitudinal direction of the accommodating space 131a (i.e., taken perpendicular to the direction in which the accommodating space 131a extends).

Although FIGS. 2 and 3 illustrate that each of the insulators 160 arranged at both end portions of the second region 132 includes a hole, but the embodiment is not limited thereto. For example, only one of the insulators 160 that is arranged at the top may include a hole for insertion of the aerosol generating article 200.

The insulator 160 may include any material having a heat insulation property. For example, the insulator 160 may include a high heat-resistance polymer material. For example, the insulator 160 may include a polymer material such as polyether ether ketone (PEEK), polyphenylsulfone (PPSU), polycarbonate (PC), polyetherimide (PEI), polyethersulfone (PES), acrylonitrile-butadiene rubber (ABS), and the like.

As another example, the insulator 160 may include a metal material. For example, the insulator 160 may include a material such as steel use stainless (SUS), aluminum (Al), and the like.

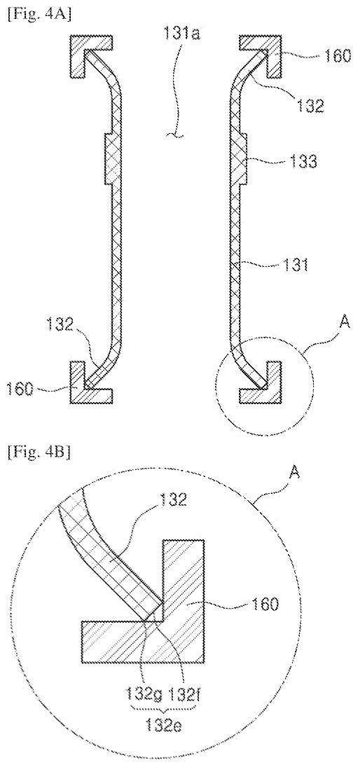

FIG. 4A is a cross-sectional view of the heater 130 and the insulator 160 of the aerosol generating device 100 according to the embodiment shown in FIG. 2. FIG. 4B is an enlarged cross-sectional view of a portion of the heater 130 and the insulator 160 of the aerosol generating device 100 according to the embodiment shown in FIG. 3.

Referring to FIGS. 4A and 4B, the insulator 160 may be coupled to the second region 132. Specifically, the insulator 160 may contact a portion 132 of the end portion 132e of the second region 132 and may be apart from a remaining portion 132f of the end portion 132e of the second region 132.

In general, an insulator coupled to an end portion of the heater having a cylindrical shape contacts an entire area of the end portion of the heater. In this case, an area in which the heater and the insulator contact each other is relatively large. Thus, the insulator may receive an excessive amount of heat from the heater, and may be heated to an excessively high temperature. When a temperature of the insulator itself increases, insulation performance of a certain level or higher expected from the insulator may not be achieved.

In addition, in the case of the insulator including a polymer material, the polymer material may melt due to a high temperature of the insulator. As the polymer material melts, a shape of the insulator may be modified, and the insulation performance of the insulator may be degraded. In addition, the melted polymer material may penetrate into other portions of the aerosol generating device and cause breakdown in the aerosol generating device.

The heater 130 of the aerosol generating device 100 according to an embodiment includes a second region 132 extending in a direction away from a center of the accommodating space 131a, and therefore a contact area between the heater 130 and the insulator 160 may be reduced as much as possible.

More particularly, as shown in FIGS. 4A and 4B, when the second region 132 is bent in a direction away from the center of the accommodating space 131a, the insulator 160 may not contact an entire area of an end portion 132e of the second region 132, while being coupled to the second region 132.

In other words, a contact area between the insulator 160 and the heater 130 relatively decreases. Thus, the amount of heat delivered to the insulator 160 may be reduced, and an excessive increase in the temperature of the insulator 160 may be prevented. Accordingly, it is possible to solve the problems such as degradation of the insulation performance or breakdown in the aerosol generating device 100 caused due to an excessive increase in the temperature of the insulator 160.

At least a portion of the surface of the second region 132 may include a material preventing dissipation of heat from the heater 130. The material preventing dissipation of the heat from the heater 130 may be deposited or coated on the surface of the second region 132, but is not limited thereto.

As the surface of the second region 132 includes a material preventing dissipation of the heat from the heater 130, the temperature of the surface of the second region 132 may be maintained relatively low, and the insulation performance to prevent the movement of the heat of the heater 130 may be further improved. When the temperature of the surface of the second region 132 adjacent to the outer surface of the aerosol generating device 100 is maintained relatively low, stability may be secured when the user uses the aerosol generating device 100.

The material preventing dissipation of the heat from the heater 130 may include a high heat-resistance polymer material, and a metal material. The high heat-resistance polymer material and the metal material used for the insulator may be also used for the heater 130.

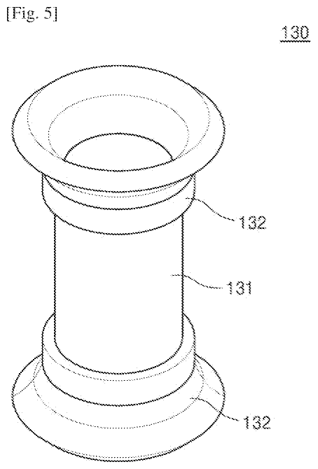

FIG. 5 is a perspective view of the heater 130 of the aerosol generating device 100 according to another embodiment. FIG. 6 is an exploded view of the heater 130 of the aerosol generating device 100 according to the embodiment shown in FIG. 5.

Referring to FIGS. 5 and 6, the second region 132 may be separably coupled to the first region 131. The second region 132 and the first region 131 may be separately fabricated, and then may be coupled to each other. Accordingly, a mass production technology may be applied to the fabrication of the second region 132 and the first region 131, and the second region 132 and the first region 131 may be easily fabricated.

The second region 132 and the first region 131 may include different materials. For example, the second region 132 may include a high heat-resistance polymer material, and the first region 131 may include a ferromagnetic substance. In this case, the second region 132 is not involved in heating of the aerosol generating article 200. The first region 131 may heat the aerosol generating article 200, and the second region 132 may prevent dissipation of the heat generated from the first region 131. As the second region 132 primarily prevents dissipation of the heat generated from the first region 131, the insulation performance to prevent dissipation of heat from the heater 130 to the outside of the aerosol generating article 100 may be further improved.

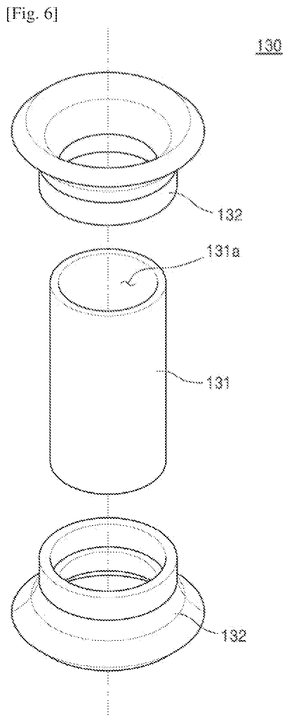

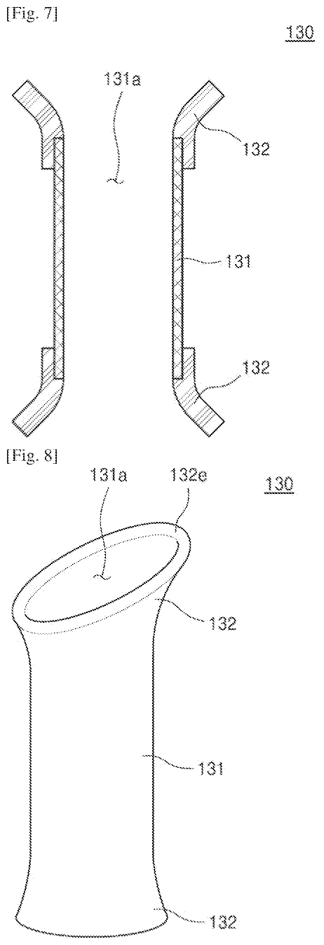

FIG. 7 is a cross-sectional view of the heater 130 of the aerosol generating device 100 according to the embodiment shown in FIG. 5.

Referring to FIG. 7, the second region 132 may be arranged along a circumference of the end portion of the first region 131. That is, as the second region 132 is coupled to the entire end portion of the first region 131, the heat in the accommodating space 131a may be prevented from being transferred to outside via the end portion of the first region 131.

In addition, the second region 132 may extend in the direction in which the accommodating space 131a extends, to thereby contact the outer surface of the first region 131. As a contact area between the second region 132 and the first region 131 increases, a coupling force between the second region 132 and the first region 131 may increase. Here, the direction in which the accommodating space 131a extends indicates a direction in which the length of the accommodating space 131a extends.

Although FIG. 7 illustrates that the second region 132 extends in the direction in which the accommodating space 131a extends, to thereby contact the outer surface of the first region 131, the embodiment is not limited thereto. The second region 132 may extend in the direction in which the accommodating space 131a extends, to thereby contact the inner surface of the first region 132, or may extend in the direction in which the accommodating space 131a extends, to thereby contact both of the inner surface and outer surface of the first region 131.

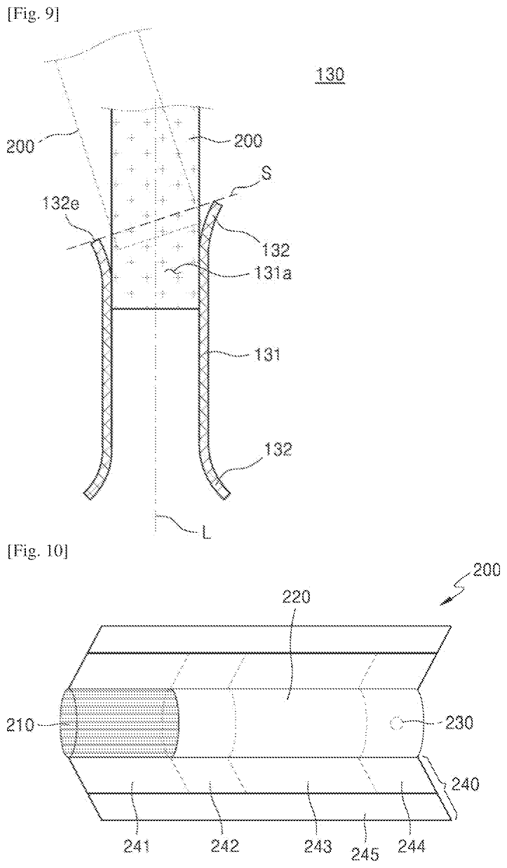

FIG. 8 is a perspective view of the heater of the aerosol generating device 100 according to another embodiment. FIG. 9 is a cross-sectional view of the heater 130 of the aerosol generating device 100 according to the embodiment shown in FIG. 8.

Referring to FIGS. 8 and 9, a surface S defined by an edge of the end portion of the second region 132 may be inclined with respect to a direction perpendicular to the direction L in which the accommodating space 131a extends. That is, compared to other regions, a certain region of the end portion 132e of the second region 132 may protrude in the direction in which the accommodating space 131a extends.

While repeatedly using the aerosol generating device 100, generally, the user habitually holds the aerosol generating device 100 in a certain direction. For example, the user may hold the aerosol generating device 100 such that a switch is positioned at a thumb of the user. The switch is arranged at an outer surface of the aerosol generating device 100 and controls the operations of the aerosol generating device 100.

As the user holds the aerosol generating device 100 in a constant pose, a direction in which the user inserts the aerosol generating article 200 into the accommodating space 131a may also be constant. In this case, by designing the second region 132 in different shapes according to regions, the aerosol generating article 200 may be more smoothly inserted into the accommodating space 131a.

That is, compared with other regions, a certain region of the end portion 132e of the second region 132 corresponding to a direction along which the aerosol generating article 200 is expected to be repeatedly inserted by the user may be designed to protrude in the direction L in which the accommodating space 131a extends. For example, a region of the end portion 132e of the second portion 132, which protrudes in the direction L in which the accommodating space 131a, may be arranged adjacent to the outer surface of the aerosol generating device 100 in which the switch is arranged, but the embodiment is not limited thereto.

Accordingly, as shown in broken lines in FIG. 9, even when the aerosol generating article 200 is inserted in a direction having a relatively great inclination with respect to a direction L in which the accommodating space 131a extends, the aerosol generating article 200 may be smoothly guided into the accommodating space 131a.

Hereinafter, examples of the aerosol generating article 200 will be described with reference to FIGS. 10 to 12.

FIG. 10 is a schematic diagram of an example of the aerosol generating article 200.

Referring to FIG. 10, the aerosol generating article 200 may include a tobacco rod 210 and a filter rod 220. A first section described in detail with reference to FIG. 1 includes the tobacco rod 210, and the second section includes the filter rod 220.

FIG. 10 illustrates that the filter rod 220 includes a single segment. However, the filter rod 220 is not limited thereto. In other words, the filter rod 220 may include a plurality of segments. For example, the filter rod 220 may include a first segment configured to cool an aerosol and a second segment configured to filter a certain component included in the aerosol. Also, as necessary, the filter rod 220 may further include at least one segment configured to perform other functions.

The aerosol generating article 200 may be packaged using at least one wrapper 240. The wrapper 240 may have at least one hole through which external air may be introduced or internal air may be discharged. For example, the aerosol generating article 200 may be packaged by one wrapper 240. As another example, the aerosol generating article 200 may be doubly packaged by two or more wrappers 240. For example, the tobacco rod 210 may be packaged by a first wrapper 241, and the filter rod 220 may be packaged by wrappers 242, 243, 244. Also, the entire aerosol generating article 200 may be re-packaged by another single wrapper 245. When the filter rod 220 includes a plurality of segments, each segment may be packaged by wrappers 242, 243, 244.

The tobacco rod 210 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet. Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transmitted to the tobacco rod 210, and thus, the heat conductivity applied to the tobacco rod may be increased and taste of the tobacco may be improved. Also, the heat conductive material surrounding the tobacco rod 210 may function as a susceptor heated by the induction heater. Here, although not illustrated in the drawings, the tobacco rod 210 may further include an additional susceptor, in addition to the heat conductive material surrounding the tobacco rod 210.

The filter rod 220 may include a cellulose acetate filter. Shapes of the filter rod 220 are not limited. For example, the filter rod 220 may include a cylinder-type rod or a tube-type rod having a hollow inside. Also, the filter rod 220 may include a recess-type rod. When the filter rod 220 includes a plurality of segments, at least one of the plurality of segments may have a different shape.

The filter rod 220 may be formed to generate flavors. For example, a flavoring liquid may be injected onto the filter rod 220, or an additional fiber coated with a flavoring liquid may be inserted into the filter rod 220.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

When the filter rod 220 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

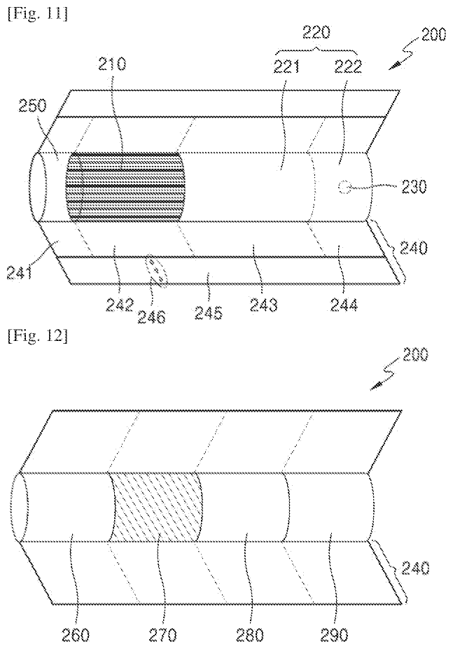

FIG. 11 is a schematic diagram of another example of the aerosol generating article 200.

Referring to FIG. 11, the aerosol generating article 200 may further include a front-end plug 250. The front-end plug 250 may be located on one side of the tobacco rod 210 which is opposite to the filter rod 220. The front-end plug 250 may prevent the tobacco rod 210 from being detached outwards and prevent the liquefied aerosol from flowing from the tobacco rod 210 into the aerosol generating device, during smoking.

The filter rod 220 may include a first segment 221 and a second segment 222. Here, the first segment 221 may correspond to the first segment of the filter rod 220 of FIG. 10, and the second segment 222 may correspond to the second segment of the filter rod 220 of FIG. 10.

A diameter and a total length of the aerosol generating article 200 may correspond to a diameter and a total length of the aerosol generating article 200 of FIG. 10. For example, the length of The front-end plug 250 is about 7 mm, the length of the tobacco rod 210 is about 15 mm, the length of the first segment 221 is about 12 mm, and the length of the second segment 222 is about 14 mm, but it is not limited thereto.

The aerosol generating article 200 may be packaged using at least one wrapper 240. The wrapper 240 may have at least one hole through which external air may be introduced or internal air may be discharged. For example, the front end plug 250 may be packaged by a first wrapper 241, the tobacco rod 210 may be packaged by a second wrapper 242, the first segment 221 may be packaged by a third wrapper 243, and the second segment 222 may be packaged by a fourth wrapper 244. Further, the entire aerosol generating article 200 may be repackaged by a fifth wrapper 245.

In addition, at least one perforation 246 may be formed in the fifth wrapper 245. For example, the perforation 246 may be formed in a region surrounding the tobacco rod 210, but is not limited thereto. The perforation 246 may serve to transfer heat generated by the heater to the inside of the tobacco rod 210.

In addition, at least one capsule 230 may be included in the second segment 222. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

FIG. 12 is a schematic diagram of another example of the aerosol generating article 200.

Referring to FIG. 12, the aerosol generating article 200 may include a first portion 260, a second portion 270, a third portion 280, and a fourth portion 290. More particularly, the first portion 260, the second portion 270, the third portion 280, and the fourth portion 290 may include an aerosol generating element, a tobacco element, a cooling element, and a filter element, respectively. For example, the first portion 260 may include an aerosol generating material, the second portion 270 may include a tobacco material and moisturizer, the third portion 280 may be configured to cool an air flow passing through the first portion 260 and the second portion 270, and the fourth portion 290 may include a filter material.

Referring to FIG. 12, the first portion 260, the second portion 270, the third portion 280, and the fourth portion 290 may be sequentially arranged with reference to a longitudinal direction of the aerosol generating article 200. Here, the longitudinal direction of the aerosol generating article 200 may be a direction in which the length of the aerosol generating article 200 extends. For example, the longitudinal direction of the aerosol generating article 200 may include a direction from the first portion 260 toward the fourth portion 290. Accordingly, the aerosol generated from at least one of the first portion 260 and the second portion 270 may sequentially pass through the first portion 260, the second portion 270, the third portion 280, and the fourth portion 290 and form an airflow, and thus, the user may puff the aerosol from the fourth portion 290.

The first portion 260 may include the aerosol generating element. In addition, the first portion 260 may include other additives such as a flavoring agent, a wetting agent, and/or organic acid, and may also include a flavoring liquid such as menthol or moisturizer. Here, the aerosol generating element may include, for example, at least one of glycerin, propylene glycol, ethylene glycol, dipropylene glycol, diethylene glycol, triethylene glycol, tetraethylene glycol, and oleyl alcohol.

The first portion 260 may include a crimped sheet, and the aerosol generating element may be included in the first region, in the state of being impregnated into the crimped sheet. In addition, other additives, such as the flavoring agent, the wetting agent and/or organic acid, and the flavoring liquid may be included in the first portion 260, in the state of being absorbed by the crimped sheet.

The crimped sheet may include a sheet including a polymer material. For example, the polymer material may include at least one of paper, cellulose acetate, lyocell, and polylactic acid. For example, the crimped sheet may include a paper sheet that does not generate an odor due to heat even when heated to a high temperature. However, the embodiment is not limited thereto.

The first portion 260 may extend from an end portion of the aerosol generating article 200 to a point of from about 7 mm to about 20 mm, and the second portion 270 may extend from the point at which the first portion 260 ends to a point of from about 7 mm to about 20 mm. However, the extension is not limited to the aforementioned numerical range, and lengths in which the first portion 260 and the second portion 270 respectively extends may be appropriately adjusted in a range which may be easily modified by those of ordinary skill in the art.

The second portion 270 may include the tobacco element. The tobacco element may include a specific type of tobacco material. For example, the tobacco element may have the form of tobacco cut fillers, tobacco particles, a tobacco sheet, tobacco beads, tobacco granules, tobacco powder, or a tobacco extract. In addition, the tobacco material may include, for example, at least one of tobacco leaves, tobacco rod, expanded tobacco, cut tobacco, and reconstituted tobacco.

The third portion 280 may be configured to cool the air flow passing through the first portion 260 and the second portion 270. The third portion 280 may be fabricated of a polymer material or a bio-degradable polymer material, and may have a cooling portion. For example, the third portion 280 may include a polylactic acid (PLA) fiber, but the material for forming the third portion 280 is not limited thereto. In some embodiments, the third portion 280 may include a cellulose acetate filter having a plurality of holes. However, the third portion 280 is not limited to the aforementioned example, and may include any material capable of cooling the aerosol. For example, the third portion 280 may include a tube filter or a paper tube filter including a hollow.

The fourth portion 290 may include the filter material. For example, the fourth portion 290 may include a cellulose acetate filter. The shape of the fourth portion 290 is not limited. For example, the fourth portion 290 may include a cylinder type rod, or may include a tube type road including a hollow therein. In addition, the fourth portion 290 may also include a recess type rod. When the fourth portion 290 includes a plurality of segments, at least one of the plurality of segments may be fabricated into a different shape.

The fourth portion 290 may be fabricated to generate flavors. For example, a flavoring liquid may be sprayed to the fourth portion 290, and a fiber coated with the flavoring agent may be inserted into the fourth portion 290.

The aerosol generating article 200 may include a wrapper 240 packaging at least a portion of the first portion 260 to the fourth portion 290. In addition, the aerosol generating article 200 may include the wrapper 240 completely packaging the first portion 260 to the fourth portion 290. The wrapper 240 may be at an outermost profile of the aerosol generating article 200. The wrapper 240 may include a single wrapper, but may also include a combination of a plurality of wrappers.

For example, the first portion 260 of the aerosol generating article 200 includes a crimped sheet including the aerosol generating material, the second portion 270 may include reconstituted tobacco leaves as the tobacco material and glycerin as the moisturizer, the third portion 280 may include a paper tube, and the fourth portion 290 may include a cellulose acetate fiber, but the embodiment is not necessarily limited thereto.

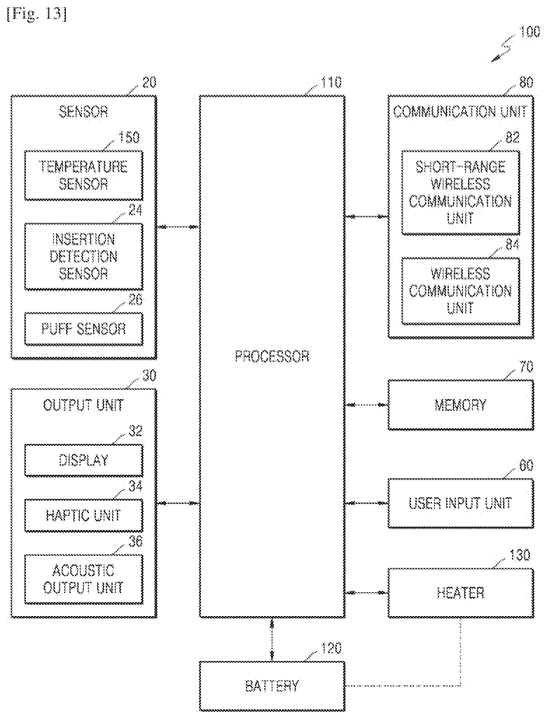

FIG. 13 is a block diagram of the aerosol generating device 100 according to another embodiment.

The aerosol generating device 100 may include the controller 110, a sensor 20, an output unit 30, the battery 120, the heater 160, a user input unit 60, a memory 70, and a communication unit 80. However, the internal structure of the aerosol generating device 100 is not limited to the block diagram of FIG. 13. That is, it will be understood to those skilled in the art that some of components shown in FIG. 13 may be omitted or other components may be added according to the design of the aerosol generating device 100.

The sensor 20 may detect the state of the aerosol generating device 100 or the state around the aerosol generating device 100, and may deliver the detected states to the controller 110. Based on the detected states, the controller 110 may control the aerosol generating device 100 to perform various functions such as controlling operation of the heater 130, restriction on smoking, determining whether the aerosol generating article (for example, a cigarette, a cartridge, and the like) is inserted, displaying notifications, and the like.

The sensor 20 may include at least one of the temperature sensor 150, an insertion detecting sensor 24, and a puff sensor 26, but is not limited thereto.

The temperature sensor 150 may detect a temperature to which the heater 130 (or the aerosol generating material) is heated. The aerosol generating device 100 may include a separate temperature sensor configured to detect the temperature of the heater 130, or alternatively, the heater 130 itself may function as a temperature sensor. Alternatively, the temperature sensor 150 may be arranged around the battery 120 to monitor a temperature of the battery 120.

The insertion detection sensor 24 may detect insertion and/or removal of the aerosol generating article. For example, the insertion detection sensor 24 may include at least one of a film sensor, a pressure sensor, an optical sensor, a resistive sensor, a capacitive sensor, an inductive sensor, an infrared ray sensor, and may detect signal changes according to insertion and/or removal of the aerosol generating article.

The puff sensor 26 may detect puffs of the user on the basis of various physical changes of the air flow path or air flow channel. For example, the puff sensor 26 may detect puffs of the user on the basis of one of temperature change, flow change, voltage change, and pressure change.

In addition to the aforementioned sensors, the sensor 20 may include at least one of a temperature/humidity sensor, an atmospheric pressure sensor, a magnetic sensor, an acceleration sensor, a gyroscope sensor, a position sensor (for example, a global positioning system (GPS)), a proximity sensor, and a red-green-blue (RGB) sensor (an illuminance sensor). Functions of the sensors may be intuitionally derived from the names by those of ordinary skill in the art, and therefore, detailed descriptions thereof may be omitted.

The output unit 30 may output information regarding the state of the aerosol generating device 100 and provide the information to the user. The output unit 30 may include at least one of a display 32, a haptic unit 34, an acoustic output unit 36, but is not limited thereto. When the display 32 and a touch pad form a layer structure and configured as a touchscreen, the display 32 may be used, in addition to an output device, as an input device.

The display 32 may visually provide the information regarding the aerosol generating device 100 to the user. For example, the information regarding the aerosol generating device 100 may indicate various kinds of information of the aerosol generating device 100 such as a charge/discharge state of the battery 120, a pre-heating state of the heater 130, an insertion/removal state of the aerosol generating article, or a state in which the use of the aerosol generating device 100 is restricted (for example, when an adverse article is detected), and the display 32 may output the information to the outside. The display 32 may include, for example, a liquid crystal display (LCD) panel, an organic light-emitting display (OLED) panel, and the like. In addition, the display 32 may have the form of a light-emitting device (LED).

The haptic unit 34 may convert an electric signal to a mechanical stimulus or an electrical stimulus and provide the information regarding the aerosol generating device 100 to the user in a tactile manner. For example, the haptic unit 34 may include a motor, a piezoelectric element, or an electric stimulation device.

The acoustic output unit 36 may provide auditory information regarding the aerosol generating device 100. For example, the acoustic output unit 36 may convert an electric signal to an acoustic signal and output the acoustic signal to the outside.

The battery 120 may supply power for operation of the aerosol generating device 100. The battery 120 may supply power for the heater 130 to be heated. In addition, the battery 120 may provide power for operations of other components (for example, the sensor 20, the output unit 30, the user input unit 60, the memory 70, and the communication unit 80) provided in the aerosol generating device 100. The battery 120 may include a rechargeable battery or a disposable battery. For example, the battery 120 may include a lithium polymer (LiPoly) battery, but is not limited thereto.

The heater 130 may receive power from the battery 120 and heat the aerosol generating material. Although not shown in FIG. 13, the aerosol generating device 100 may further include a power conversion circuit (for example, a direct current (DC)/DC converter) configured to convert the power of the battery 120 and provide the power to the heater 130. In addition, when the aerosol generating device 100 generates an aerosol in an induction method, the aerosol generating device 100 may further include a DC/alternating current (AC) converter configured to convert the direct power of the battery 120 to the alternating power.

The controller 110, the sensor 20, the output unit 30, the user input unit 60, the memory 70, and the communication unit 10 may receive power from the battery 120 and perform functions. Although not shown in FIG. 13, may further include a power conversion circuit configured to convert the power of the battery 120 and provide the power to the respective components, for example, a low dropout (LDO) circuit or a voltage regulator circuit.

In an embodiment, the heater 130 may be formed of an arbitrary suitable electric resistance material. For example, the suitable electric resistance material may include a metal or metal alloy including titanium, zirconium, tantalum, platinum, nickel, cobalt, chromium, hafnium, niobium, molybdenum, tungsten, tin, gallium, manganese, iron, copper, stainless steel, nichrome, but is not limited thereto. In addition, the heater 130 may be implemented as a metal wire, a metal plate on which an electrically conductive track is arranged, a ceramic heating body, and the like, but is not limited thereto.

In other embodiments, the heater 130 may include an induction heater. For example, the heater 130 may include a susceptor configured to generate heat due to the magnetic field applied by the coil and heat the aerosol generating article.

The user input unit 60 may receive information input by the user or output information to the user. For example, the user input unit 60 may include a key pad, a dome switch, a touchpad (a contacting capacitive method, a resistive overlay method, an infrared beam method, a surface acoustic wave method, an integral strain gauge method, a piezoelectric effect method, and the like), a jog wheel, a jog switch, and the like, but is not limited thereto. In addition, although not shown in FIG. 13, the aerosol generating device 100 may further include a connection interface such as a universal serial bus (USB) interface, and may transmit/receive information or charge the battery by being connected to another external device via the connection interface such as the USB interface.

The memory 70, which is hardware configured to store various kinds of data processed in the aerosol generating device 100, may store data that has been processed or to be processed in the processor 110. The memory 70 may include at least one type of storage medium from among memories of flash memory type, hard disk type, multimedia card micro type, card type (for example, an SD memory or XD memory), a random access memory (RAM), a static random access memory (SRAM), a read-only memory (ROM), an electrically erasable programmable read-only memory (EEPROM), programmable read-only memory (PROM), a magnetic memory, a magnetic disk, and an optical disk. The memory 70 may store data regarding an operation time period of the aerosol generating device 100, a maximum number of puffs, a current number of puffs, at least one temperature profile, and a smoking pattern of the user.

The communication unit 80 may include at least one component for communication with other electronic devices. For example, the communication 80 may include a short-range wireless communication unit 82 and a wireless communication unit 84.

The short-range wireless communication unit 82 may include a Bluetooth communication unit 20, a Bluetooth Low Energy (BLE) communication unit, a Near Field Communication unit, a wide local area network (Wi-Fi) communication unit, a Zigbee communication unit, an infrared Data Association (IrDA) communication unit, a Wi-Fi Direct (WFD) communication unit, an ultra wideband (UWB) communication unit, an Ant+ communication unit, but is not limited thereto.

The wireless communication unit 84 may include a cellular network communication unit, an Internet communication unit, a computer network (for example, a local area network (LAN) or a wide area network (WAN) communication unit, but is not limited thereto. The wireless communication unit 84 may confirm and authenticate the aerosol generating device 100 in the communication network by using subscriber information (for example, an International Mobile Subscriber Identity (IMSI)).

The controller 110 may control general operations of the aerosol generating device 100. In an embodiment, the controller 110 may include at least one processor. The processor may be implemented as an array of a plurality of logic gates, and may also be implemented as a combination of a general-purpose microprocessor and a memory configured to store a program executable by the microprocessor. In addition, those of ordinary skill in the art may understand that the processor may also be implemented as other types of hardware.

The controller 110 may control the temperature of the heater 130 by controlling supply of the power of the battery 120 to the heater 130. For example, the controller 110 may control power supply by controlling switching of the switching device between the battery 120 and the heater 130. In other embodiments, a heating integrated circuit may control power supply to the heater 130 in response to a control command of the controller 110.

The controller 110 may analyze a result detected by the sensor 20 and control processing operations to be performed later. For example, the controller 110 may control power supplied to the heater 130 to initiate or end operations of the heater 130, on the basis of the result detected by the sensor 20. As another example, on the basis of the result detected by the sensor 20, the controller 110 may control an amount of power supplied to the heater 130 and a time for supplying power such that the heater 130 may be heated to a certain temperature or may maintain an appropriate temperature.

The controller 110 may control the output unit 30 on the basis of the result detected by the sensor 20. For example, the number of puffs counted by the puff sensor 26 reaches a preset number, the controller 110 may notify the user, via at least one of the display unit 32, the haptic unit 34, and the acoustic output unit 36, that the operations of aerosol generating device 100 will be finished soon.

One embodiment may also be implemented in the form of a recording medium including instructions executable by a computer, such as a program module executable by the computer. The computer-readable recording medium may be any available medium that can be accessed by a computer, including both volatile and nonvolatile media, and both removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

Those of ordinary skill in the art related to the present embodiments may understand that various changes in form and details can be made therein without departing from the scope of the characteristics described above. Therefore, the disclosed methods should be considered in a descriptive point of view, not a restrictive point of view. The scope of the present disclosure is defined by the appended claims rather than by the foregoing description, and all differences within the scope of equivalents thereof should be construed as being included in the present disclosure.

1. An aerosol generating device comprising:
a heater comprising an accommodating space for accommodating an aerosol generating article; and
a coil configured to heat the heater by generating a magnetic field, wherein the heater comprises:
a first region arranged to contact the aerosol generating article; and
a second region arranged at at least one of two ends of the first region and extending in a direction away from a center of the accommodating space.

2. The aerosol generating device of claim 1, wherein the first region comprises a protrusion portion protruding in the direction away from the center of the accommodating space.

3. The aerosol generating device of claim 1,
wherein the first region comprises a protrusion portion protruding in the direction away from the center of the accommodating space, and
wherein the aerosol generating device further comprises a temperature sensor arranged on the protrusion portion and configured to detect a temperature of the heater.

4. The aerosol generating device of claim 1, further comprising an insulator coupled to at least a portion of the second region and configured to prevent heat of the heater from being transferred to outside.

5. The aerosol generating device of claim 1,
further comprising an insulator coupled to the second region, contacting a part of an end portion of the second region without contacting a remaining part of the end portion of the second region, and configured to prevent the heat of the second region from being transferred to outside.

6. The aerosol generating device of claim 1, wherein a surface of the second region comprises a material preventing dissipation of heat of the heater.

7. The aerosol generating device of claim 1, wherein the second region is separably coupled to the first region and comprises a material different from a material of the first region.

8. The aerosol generating device of claim 1, wherein a surface defined by an edge of an end portion of the second region is inclined with respect to a direction perpendicular to a direction in which the accommodating space extends.

9. A heater for an aerosol generating device, the heater comprising:
an accommodating space for accommodating an aerosol generating article;
a first region arranged to contact the aerosol generating article; and
a second region arranged at at least one of two ends of the first region and extending in a direction away from a center of the accommodating space.

10. The heater of claim 9, wherein the first region comprises a protrusion portion protruding in the direction away from the center of the accommodating space.

11. The heater of claim 9, wherein a surface of the second region comprises a material preventing dissipation of heat from the heater.

12. The heater of claim 9, wherein the second region is separably coupled to the first region and comprises a material different from a material of the first region.

13. The heater of claim 9, wherein a surface defined by an edge of an end portion of the second region is inclined with respect to a direction perpendicular to a direction in which the accommodating space extends.
